(19) United States
(12) Patent Application Publication
(10) Pub. No.: US 2022/0042546 A1
(43) Pub. Date: Feb. 10, 2022

(54) BEARING HOUSING AND A METHOD OF REMOVING IMPURITIES FROM A BEARING HOUSING

(71) Applicant: Sulzer Management AG, Winterthur (CH)

(72) Inventors: Seppo NYMAN, Poitsila (FI); Janne RIPATTILA, Kouvola (FI)

(21) Appl. No.: 17/281,340

(22) PCT Filed: Nov. 27, 2019
(86) PCT No.: PCT/EP2019/082731

§ 371 Date: Mar. 30, 2021

(30) Foreign Application Priority Data
Dec. 4, 2018 (EP) 18210244.2

(51) Int. Cl. F16C 33/66; B01D 21/24; F16C 35/04; F16N 31/00; F16N 39/00

(52) U.S. Cl. CPC F16C 33/6685; B01D 21/2483; F16C 35/042; F16N 2210/14; F16N 39/00; F16C 2320/16; F16C 2360/44; F16N 31/00

(57) ABSTRACT

A bearing housing includes a hollow shell with opposite ends having coaxial openings for at least one bearing element at each end thereof. The shell between the openings has, when assembled in position for use, a bottom with a bottom surface, the bottom having an oil outlet and the bottom surface having an oil outlet opening. The cavity for impurities is arranged below the bottom surface of the shell, and the cavity is arranged in flow communication with the oil outlet and the oil outlet opening.

### CROSS-REFERENCE TO RELATED APPLICATIONS

This application is a U.S. National Stage application of International Application No. PCT/EP2019/082731, filed Nov. 27, 2019, which claims priority to European Patent Application No. 18210244.2, filed Dec. 4, 2018, the contents of which are hereby incorporated herein by reference.

### BACKGROUND

### Field of the Invention

The present invention relates to a bearing housing and a method of removing impurities from the bearing housing. More generally, the present invention relates to bearing housings used in connection with various machines, like for instance centrifugal pumps, radial pumps, agitators, mixers, etc.

### Background Information

Normally, the oil used for lubricating the bearings is contaminated in a few different ways. Impurities found in the lubricating oil can be originating from the wear of the bearing balls, rollers, inner and outer races or cages. Impurities can also loosen from the interior surface of the bearing housing, and impurities can also get into the bearing housing from outside thereof, due to, for instance, a seal failure.

Usually the impurities sink to the bottom of the housing, but it is not uncommon that the circulation of oil and the turbulence prevailing in the bearing housing keep the impurities moving, at least the smallest or the lightest ones such that they get into contact with the bearing surfaces and speed up the wear thereof.

### SUMMARY

For the above reason, it is been found that it is common practice that the machine, for instance a pump, is stopped from time to time for the oil change. Such stopping of the pump, or any other device, may require that a process line is run down, or a second pump or device is arranged to the side of the pump to be serviced. And also, in connection with normal oil changes it is possible that the impurities sank and settled on the bottom of the bearing housing remain in the bearing housing, i.e. the impurities have formed a sticky paste-like material that does not in itself loosen from the bottom of the bearing housing. Such paste-like material cannot normally be removed from the bearing housing as the removal may, at its worst, require mechanical working on the material until it is loosened from the surface of the housing.

An object of the present invention is to provide a novel bearing housing the use of which overcomes at least one of the prior art problems.

At least some objects of the present invention can be met substantially as is disclosed herein which describe details of different embodiments of the invention.

According to an embodiment of the present invention a bearing housing comprises a hollow shell with opposite ends having coaxial openings for at least one bearing element at each end thereof, wherein the shell between the openings has, when assembled in position for use, a bottom with a bottom surface, the bottom having an oil outlet and the bottom surface having an oil outlet opening, wherein a cavity for impurities is arranged below the bottom surface of the shell, the cavity being arranged in flow communication with the oil outlet and the oil outlet opening and the bearing housing comprises a first valve arranged between the cavity for impurities and the outlet in the bottom of the shell.

According to an embodiment of the invention, the cavity includes a cleaning access into its internal space, for removing accumulated impurities.

According to an embodiment of the invention, the bearing housing comprises a second valve, wherein the cavity is arranged between the first valve and the second valve.

Advantageously the second valve is arranged at a bottom of the cavity for impurities.

According to an embodiment, the bearing housing comprises a discharge pipe, and the second valve is disposed in the discharge pipe at a distance from the first valve, and the cavity for impurities is left between the first and the second valve in the discharge pipe.

Thus, a bearing housing for various pumps, mixers and agitators, for instance, is provided, the performance of which is considerably improved. In other words, the oil in the bearing housing can be kept in good working condition for longer periods of time by only removing impurities from the oil. The removal of the impurities can be performed without stopping the machine the bearing housing is coupled to, whereby the downtime of the machine is considerably reduced. Also by allowing the impurities to settle in a cavity that can be cleaned without stopping the machine prevents paste-like impurities from being formed on the bottom surface of the bearing housing.

According to an embodiment of the invention a method of removing impurities from a bearing housing comprising a shell having, when assembled in position for use, a bottom with a bottom surface and an outlet for oil, comprises the steps of:
a) providing the bearing housing with a cavity below the bottom surface, in flow connection with the bearing housing via the outlet, and with a first valve
b) maintaining the first valve open
c) allowing impurities to settle in the cavity, and
d) closing the first valve and discharging impurities from the cavity.

According to an embodiment of the invention a first valve and a second valve are arranged such that the cavity is formed between the two valves, and in the step d) the method comprises closing the first valve and opening the second valve and discharging impurities from the cavity.

According to an embodiment of the invention after discharging impurities from the cavity, the cavity is filled with oil via the second valve, the second valve is closed and the first valve is opened.

According to an embodiment of the invention the method further arranging a removable impurity trap in connection with the first valve wherein the step of discharging impurities from the cavity comprises removing the impurity trap arranged in connection with the first valve.

Invention provides several advantageous effects. The bearing housing according to the invention allows the impurities to be removed without a need to replace all the oil prevailing in the bearing housing.

Further in the bearing housing according to embodiments of the invention, the impurities are collected in a cavity where the oil flow is not as turbulent as in the rest of the oil space in the bearing housing, improving the settling of the impurities in the cavity.

The exemplary embodiments of the invention presented in this patent application are not to be interpreted to pose limitations to the applicability of the appended claims. The verb “to comprise” is used in this patent application as an open limitation that does not exclude the existence of also unrecited features. The features recited in dependent claims are mutually freely combinable unless otherwise explicitly stated. The novel features which are considered as characteristic of the invention are set forth in particular in the appended claims.

### BRIEF DESCRIPTION OF DRAWINGS

The invention will be explained in more detail hereinafter with reference to the drawings.

FIG. 1 illustrates a side view of a bearing housing in accordance with an embodiment of the present invention,

FIG. 2 illustrates an isometric view of a bearing housing of FIG. 1,

FIG. 3 illustrates an enlarged schematical partial cross section of the bottom part of the bearing housing according to an embodiment of the invention, and

FIG. 4 illustrates an enlarged schematical partial cross section of the bottom part of the bearing housing in accordance with another embodiment of the present invention,

### DETAILED DESCRIPTION

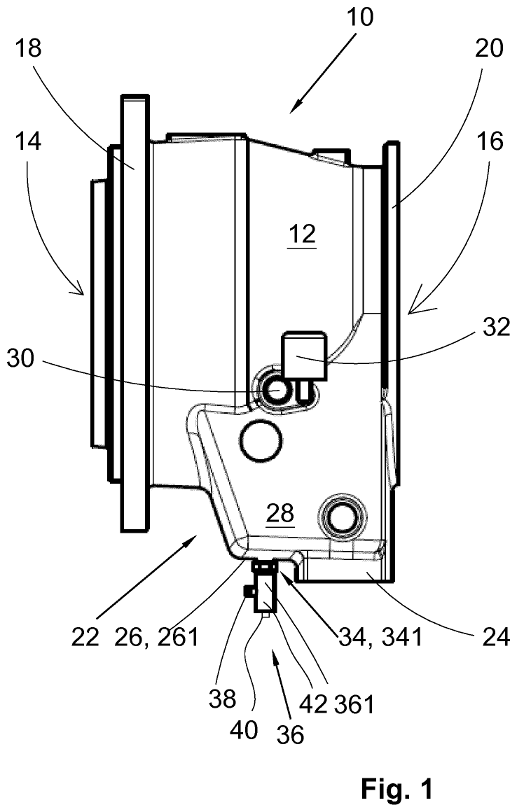

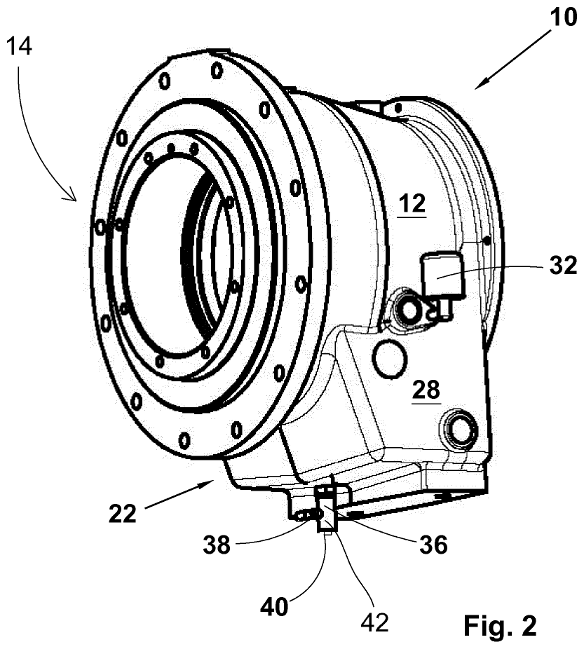

FIG. 1 depicts a side view of a bearing housing 10 and FIG. 2 depicts an isometric view of the bearing housing 10 in accordance with an embodiment of the present invention. The bearing housing 10 normally has a tubular shape, i.e. it has a hollow shell 12 with circular openings 14 and 16 at its both ends. The cross section of the shell 12 normally has a cylindrical, rectangular or square shape, though, naturally, the cross section of the shell can have any imaginable shape that fits with the use of the shell. The openings 14 and 16 are coaxial so that a shaft can run through the bearing housing 10. The openings 14 and 16 are configured to provide attachment of bearings for the shaft. Normally, there is one bearing or a set of bearings installed at each opening, and the openings can have the same or a different diameter. One or both openings 14 and 16 can be surrounded with flange/s 18 and 20, respectively, so that the bearing housing 10 can be fastened to neighbouring components of the machine. The shell 12 can include, at its bottom part 22, when assembled in position for use, a separate means (or element) 24 or an extension or leg for fastening the bearing housing 10 to a base plate, for example. For instance, if the bearing housing 10 is used for supporting a pump shaft, the bearing housing 10 can have at its one end a flange 18 to which the pump volute is fastened and the shell 12 can have at its bottom 26 a fixed or removable leg 24 extending down to a base plate on which the pump volute is also supported.

As the actual space between the openings 14 and 16 in the bearing housing 10 as well as the diameter, or, rather, an internal dimension at right angles to the axis, of the shell 12 can be relatively small the shell 12 can, as shown in FIG. 1, include an oil chamber 28 so that some more oil can be disposed in the bearing housing 10. The surface area of the oil chamber 28 increases the cooling surface for the oil, whereby it can be ensured that the oil remains in its desired temperature range in all available operating conditions the bearing housing 10 may experience. The side wall of the shell 12 includes, preferably but not necessarily, a sight glass 30 by which it is easy to check or to inspect that the oil in the bearing housing 10 is at its desired level. The sight glass 30 can be replaced with any known means for determining liquid level in a vessel. The side wall of the shell 12, or the shell 12 in general, includes, in this embodiment at a side of the sight glass 30, h a cup or funnel 32 for adding oil. In other words, when it is detected that the oil level in the bearing housing 10 has decreased oil can be added via the cup or funnel 32 to reach the desired oil level again.

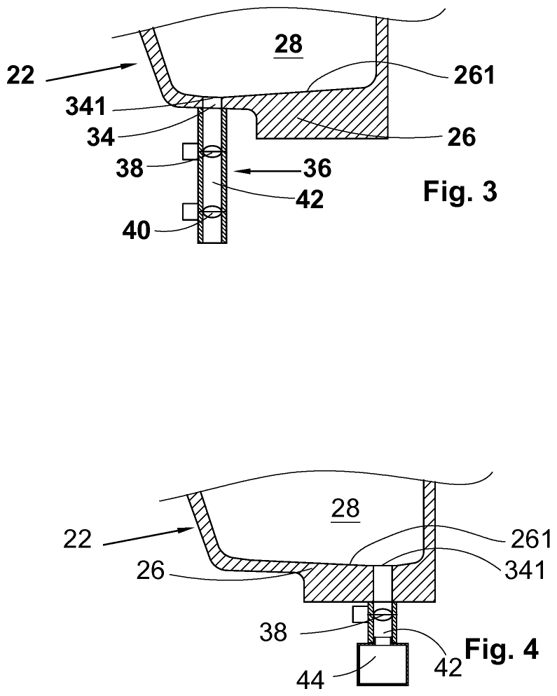

The bottom 26 of the bearing housing 10 or that of the shell 12, which is also the bottom 26 of the oil chamber 28 of the shell 12, includes an outlet 34 and an outlet opening 341. The bottom of the shell 12 is shown in the embodiments of FIGS. 3 and 4 in more detailed manner describing another optional embodiments of the invention. Applying also the embodiment shown in FIGS. 1 and 2, the inner bottom surface 261 of the bottom 26 of the bearing housing 10 or that of the shell 12 tapers towards the outlet opening 341 such that the impurities can collect in the lowermost part of the bottom 26, i.e. into the outlet opening 341 and sink in the outlet 34. However, now in accordance with embodiments of the present invention the outlet 34 does not include an ordinary plug but a downwardly extending discharge pipe 36 or alike including a first valve 38 and a cavity 42 for impurities behind the first vale 38, when seen from the inside of the housing 10. The first valve is illustrated in a very schematical and exemplary manner in the drawings. The type of the first valve 38 can vary, and is by no means limited to the shown butterfly valve. Advantageously the first valve 38 is a manually operated valve. The discharge pipe 36 and the first valve 38 function such that the impurities not only move to the lowermost part of the bottom 26/261 but sink inside the discharge pipe 36 and settle below the first valve 38, i.e. into a pipe section 361 forming the cavity 42 below the first valve 38. The pipe section 361 forms a cavity below the bottom surface 261, and the outlet opening 341, of the shell 12 for the impurities to collect. Now that the first valve 38 is maintained open, the impurities from the housing 10 falls into the cavity and the pipe section 361 of the discharge pipe 36. The cavity includes a cleaning access thereto, i.e. its internal space inside the cavity for removing the impurities accumulated therein. In the embodiment shown in FIGS. 1 and 2 the pipe section 361 is plugged, or otherwise closed, at its end by a plug 40, or alternatively includes a removable bottom. The plug can be functionally referred to as a second valve 40. The first valve 38 is normally maintained open allowing impurities to settle in the cavity, and when needed or desired, the first valve 38 is closed and the impurities are discharged from the cavity 42 by opening the plug 40 at the end of the discharge pipe 36. Now that the first valve 38 is closed all the time needed for proper cleaning the cavity 42 carefully can be taken. As the volume of the cavity is substantially small, only a limited amount of oil is taken out of the bearing housing 10, whereby the oil level descends only a little. The oil level can be returned to its exactly correct level by adding oil via the cup or funnel 32. Oil can also, naturally, be added to the cup/funnel 32 during the bleeding of the impurities such that the oil level does not, in practice, change at all.

FIG. 3 depicts an enlarged schematical partial cross section of the bottom part 22 of the bearing housing in accordance with an embodiment of the present invention. In fact, the embodiment shown in FIG. 2 is such a variation of the above discussed FIGS. 1 and 2 that the discharge pipe 36 includes the first valve 38 and a second valve 40 at a distance from the first valve 40, when assembled in position for use, below the first valve 38 such that a cavity 42 for impurities is formed between the two valves 38 and 40. The second valve 40 is closed and the first valve 38 open in normal running conditions. The above arrangement functions such that the impurities first move along the inclined bottom surface 261 of the oil chamber 28 or the bottom area of the shell towards the outlet opening 34 and then sink into the discharge pipe 36 and settle to the cavity 42 between the first valve 38 and the second valve 40, i.e. well below the bottom surface 261 of the shell. After a certain period of time the first valve 38 is closed and the second valve 40 is opened to bleed the impurities from the discharge pipe 36. Now that the first valve 38 is closed the discharge pipe 36 and the second valve 40 below the first valve 38 can be, if desired, flushed, rinsed or mechanically cleaned, for instance by brushing as there is no risk of further lowering the oil level in the bearing housing. When the impurities are removed, and the discharge pipe 36, possibly, cleaned, the second valve 40 is closed and the first one 38 opened. While opening the first valve 38 oil is added via the cup/funnel (see referenced numeral 32 in FIG. 1) to maintain the desired oil level in the bearing housing.

The above discussed embodiment can be simplified with a variation where the first valve 38 is coupled directly to the bottom 26 of the oil chamber 28 or shell, and the discharge pipe 36 to the first valve 38. Otherwise both the construction and the function thereof is as discussed above.

FIG. 4 depicts an enlarged schematical partial cross section of the bottom part 22 of the bearing housing in accordance with another embodiment of the present invention. In practice, the embodiment shown in FIG. 4 is a further development of, and applicable to other embodiments such that a removable impurity trap 44 is attached in connection with, or behind (seen from the inside of the housing 10) the first valve 38, forming at least a lower part of the cavity 40, to the lower end of the discharge pipe 36 when the bearing housing is assembled in position for use. The arrangement functions such that the impurities first move along the inclined bottom surface 261 of the oil chamber 28 towards the outlet opening 341 and then sink in normal running conditions into the discharge pipe 36, or directly to the cavity 42 and settle in the impurity trap 44 below the valve 38. After a certain period of running time the valve 38 is closed and the impurity trap 44 is removed from the end of the discharge pipe 36, or the bottom of the housing 10, for emptying and cleaning. Now that the first valve 38 is closed all the time needed for cleaning the impurity trap 44 carefully can be taken. When the impurities are removed from the impurity trap 44 and the impurity trap 44 cleaned, the impurity trap 44 is fastened back to the lower end of the discharge pipe 36, and the first valve 38 can be opened. While the valve 38 is opened the impurities sank in the discharge pipe 36 will further descend into the impurity trap 44. Thus, when the arrangement comprises a removable trap 44, only one valve 38 is needed for the bearing housing.

As is shown in FIG. 4 the arrangement can be simplified with a variation where the first valve 38 is coupled directly to the shell, the leg or the bottom of the oil chamber 28 or shell, and the impurity trap 44 to the first valve 38.

While the invention has been described herein by way of examples in connection with what are, at present, considered to be the most preferred embodiments, it is to be understood that the invention is not limited to the disclosed embodiments, but is intended to cover various combinations or modifications of its features, and several other applications included within the scope of the invention, as defined in the appended claims. The details mentioned in connection with any embodiment above can be used in connection with another embodiment when such combination is technically feasible.

1. A bearing housing comprising:
a hollow shell with opposite ends having coaxial openings for at least one bearing element at each end thereof, the shell between the openings having, when assembled in position for use, a bottom with a bottom surface, the bottom having an oil outlet and the bottom surface having an oil outlet opening;
a cavity for impurities arranged below the bottom surface of the shell, the cavity being arranged in flow communication with the oil outlet and the oil outlet opening; and
a first valve arranged between a closed cavity for impurities and the outlet in the bottom of the shell.

2. The bearing housing as recited in claim 1, wherein the cavity includes a cleaning access into an internal space thereof.

3. The bearing housing as recited in claim 1, further comprising a second valve, and the closed cavity is between the first valve and the second valve.

4. The bearing housing as recited in claim 3, wherein the second valve is arranged at the bottom of the cavity for impurities.

5. The bearing housing as recited in claim 1, further comprising a discharge pipe in flow communication with the outlet.

6. The bearing housing as recited in claim 5, wherein the discharge pipe forms, at least partially, the cavity for the impurities.

7. (canceled)

8. The bearing housing as recited in claim 1, further comprising a second valve disposed in a discharge pipe at a distance from the first valve, and the cavity for impurities being between the first and the second valve in the discharge pipe.

9. The bearing housing as recited in claim 7, wherein an impurity trap is arranged at an end of the discharge pipe.

10. The bearing housing as recited in claim 9, wherein the impurity trap is a removable cup.

11. The bearing housing as recited in claim 1, wherein the bottom surface is inclined towards the outlet opening.

12. A method of removing impurities from a bearing housing comprising a shell having, when assembled in position for use, a bottom with a bottom surface and an outlet for oil in the bottom, the method comprising:
providing the bearing housing with a closed cavity below the bottom surface in flow connection with the bearing housing via the outlet, and with a first valve in flow communication with the outlet for oil, between the closed cavity and the outlet in the bottom of the shell,
maintaining the first valve open,
enabling impurities to settle in the closed cavity, and
d) closing the first valve and discharging impurities from the closed cavity.

13. The method as recited in claim 12, wherein the providing includes providing the first valve and a second valve such that the cavity is formed between the first and second valves, and the closing the first valve includes opening the second valve and discharging the impurities from the cavity.

14. The method as recited in claim 12, further comprising after the discharging the impurities from the cavity, filling the cavity with oil via the second valve, closing the second valve and opening the first valve.

15. The method as recited in claim 12, further comprising arranging a removable impurity trap in connection with the first valve and the discharging the impurities from the cavity comprising removing the impurity trap arranged in connection with the first valve.
